(19) United States
(12) Patent Application Publication
(10) Pub. No.: US 2016/0137004 A1
(43) Pub. Date: May 19, 2016

(54) LOW-NOISE TREAD FOR HEAVY VEHICLES

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: BENJAMIN QUANTINET, Clermont-Ferrand (FR); FABIEN MARLIER, Clermont-Ferrand (FR)

(73) Assignees: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(21) Appl. No.: 14/904,177

(22) PCT Filed: Jul. 8, 2014
(86) PCT No.: PCT/EP2014/064642

§ 371 Date: Jan. 11, 2016

(30) Foreign Application Priority Data
Jul. 9, 2013 (FR) 1356742

(51) Int. Cl. B60C 11/03; B60C 11/12; B60C 11/11

(52) U.S. Cl. CPC B60C 11/0318; B60C 11/0302; B60C 11/0304; B60C 11/0306; B60C 11/11; B60C 11/12; B60C 2011/0341; B60C 2011/0372; B60C 2011/0325

(57) ABSTRACT

Tread for a tire to equip a heavy vehicle, having:—a plurality of grooves of circumferential overall orientation and a plurality of grooves of oblique overall orientation intersecting the circumferential grooves to delimit blocks, these circumferential and transverse grooves forming a directional tread pattern, imposing a running direction on the tread, a dividing plane separating part of the pattern to the left and part of the pattern to the right,—the circumferential grooves delimiting at least three intermediate rows of blocks and two edge rows situated axially on the outside of the intermediate rows, wherein each block has a contact face forming part of the tread surface, a front face and a rear face and two lateral faces, the front face and the rear face intersecting the contact face along a leading edge Ai and a trailing edge Fi respectively, Ai coming into the contact patch during running before Fi of the same block when running in the running direction, wherein Ai of all the blocks are offset from one another in the circumferential direction such that: they successively enter the contact patch during running,—they enter the contact patch alternately on one side of the dividing plane and then on the other side of the same dividing plane in a back-and-forth arrangement.

This application is a 371 national phase entry of PCT/EP2014/064642, filed 8 Jul. 2014, which claims benefit of French Patent Application No. 1356742, filed 9 Jul. 2013, the entire contents of which are incorporated herein by reference for all purposes.

### BACKGROUND

1. Field

The present disclosure relates to treads for the tires of heavy vehicles and more particularly to an improvement in the tread pattern of these treads to allow an appreciable reduction in miming noise.

2. Description of Related Art

A tire for heavy vehicles the tread of which is provided with a tread pattern that is not symmetric about the midplane is known, notably from patent application JP 3-271003; this midplane passes through the radially outermost points of the tire and divides the tire into two parts.

In that document, the tread pattern is directional, which means to say that there is a preferred direction of running Moreover, this tread has, on either side of a plane distinct from the equatorial plane, tread patterns which are not symmetrical.

For the treads of heavy vehicle tires on the driven axle it is necessary for there to be cavities in order to give the tire a suitable level of grip that a driving and/or braking torque can be transmitted while at the same time generating an appropriate volumetric capacity for the storage of water in the wet.

These cavities are usually formed by grooves themselves arranged in the longitudinal direction (also referred to as circumferential direction) of the tread and in the transverse (also referred to as axial) direction or even obliquely.

When a heavy vehicle equipped with tires thus provided with grooves runs along a roadway, the edges delimiting each transverse groove entering the contact patch and leaving the patch in contact with the roadway generate noise. The sum of the sound emissions generated by all of the edges of all of the transverse grooves entering and leaving the contact patch constitutes a frequency spectrum and generates a fairly significant overall level of noise.

Standards, which differ according to the geographical region, have imposed reductions in the overall noise emitted by the tires. Changes to the standards as announced for 2017, have generated a need to obtain tires the running noise of which will be reduced by at least 2 dBA.

Compliance with these standards requires a suitable design of tires, notably tires intended to be mounted on a drive (aka driven) axle.

It is in this context that research teams are working to lower the level of noise without adversely affecting the other performance aspects of the tires.

### DEFINITIONS

Midplane (or equatorial plane): is a plane perpendicular to the axis of rotation of a tire and passing through the points on the said tire that are radially furthest away from the said axis. This plane divides the tread into two halves of equal axial width.

A block is a raised element formed on the tread which is delimited by voids or grooves and comprises lateral walls and a contact face intended to come into contact with the roadway during running The intersection of each lateral wall with the contact face forms an edge.

A rib is a raised element formed on a tread, this element extending in the circumferential direction and making a complete circuit of the tire. A rib comprises two lateral walls and a contact face, the latter being intended to come into contact with the roadway during running.

The radial direction in this document means a direction that is perpendicular to the axis of rotation of the tire (this direction corresponds to the direction of the thickness of the tread).

A transverse or axial direction means a direction parallel to the axis of rotation of the tire.

A circumferential direction means a direction tangential to any circle centred on the axis of rotation. This direction is perpendicular both to the axial direction and to a radial direction.

Axially outwards means a direction parallel to the axis of rotation of the tire and directed towards the outside of the internal cavity of the tire.

The usual running conditions of the tire or conditions of use are those defined by the E.T.R.T.O. standard; these conditions of use specify the reference inflation pressure corresponding to the load-bearing capability of the tire as indicated by its load rating and its speed code. These conditions of use may also be referred to as “nominal conditions ” or “service conditions”.

A cut generically either refers to a groove or to a sipe and corresponds to the space delimited by walls of material that face one another and are distant from one another by a non-zero distance (referred to as the “width of the cut”). It is precisely this distance that differentiates a sipe from a groove; in the case of a sipe this distance is suitable for allowing the opposing walls that delimit the said sipe to come into at least partial contact at least when they are in the contact patch in contact with the roadway. In the case of a groove, the walls of this groove cannot come into contact with one another under usual running conditions.

The collection of cuts made in a tread forms a tread pattern. This tread pattern is said to be directional when it imposes a preferred direction of running; this preferred direction of running may be indicated on the tread by a sign visible to the user making it easier to mount the tire on the vehicle.

### SUMMARY

The present invention, in its embodiments, seeks to obtain a family of tread pattern designs for tires intended notably to be fitted to a drive axle of a heavy vehicle, this tread pattern design giving the tire good performance in terms of wear and in terms of traction and in terms of running noise.

To this end, one subject of an embodiment of the invention is a tread for a tire intended to equip a heavy vehicle, this tread comprising a tread surface intended to come into contact with a roadway and to form a contact patch, this tread comprising:

a plurality of grooves of circumferential overall orientation and a plurality of grooves of oblique overall orientation intersecting the grooves of circumferential overall orientation to delimit blocks, these circumferential and oblique grooves forming a directional tread pattern, this directional tread pattern imposing a preferred running direction on the tread,

a dividing plane separating part of the pattern on one side of the said plane and part of the pattern on the other side,

the circumferential grooves delimiting at least three intermediate rows formed of a plurality of blocks and two edge rows situated axially on the outside of the intermediate rows.

This tread is such that each block of the rows of blocks comprises a contact face forming part of the tread surface, a front face and a rear face and two lateral faces,

the front face and the rear face intersecting the contact face along a leading edge and a trailing edge respectively, the leading edge of a block coming into the contact patch during running before the trailing edge of the same block when the tread is running in the running direction.

This tread is characterized in that its pattern is designed so that the leading edges of all the blocks of the rows formed of blocks are inclined and offset from one another in the circumferential direction in a suitable way that:

these leading edges successively enter the contact patch,

these leading edges enter the contact patch alternately on one side of the dividing plane and then on the other side of the said dividing plane in a kind of back-and-forth arrangement.

The leading edges successively come into the contact patch in contact with the roadway during running which means that only one leading edge at a time enters the contact patch.

The distribution of the leading edges is such that, during running, after a leading edge situated on a first side of the dividing plane has come into contact with the roadway, another leading edge situated on the second side with respect to the same plane then comes into contact with the roadway, then followed by an edge situated on the first side of the dividing plane and so on. It is possible for there to be a small degree of overlap—at most 10% of the length of the longest edge, which means to say that a first edge has 90% of its length in the contact patch when another edge situated on the other side of the dividing plane begins likewise to enter the contact patch. For preference though it is desirable for the edges to come into contact successively with no overlap.

The way in which the leading edges are arranged, with their being inclined with respect to the transverse direction by an angle greater than zero degrees, causes the said edges and oblique grooves to enter the contact patch in succession, allowing the amplitudes of the acoustic harmonics to be modulated during running thereby reducing the overall noise emissions of the tire during running.

Of course, having the leading edges entering the contact patch in succession means that the trailing edges of the same blocks will enter the contact patch in succession.

In an optimized alternative form of the invention, it is sensible for another leading edge on the other side to start to enter the contact patch at the same time as a leading edge on one side of the tread finishes occupying the contact patch. Geometrically, what that means to say is that the end of the last leading edge forming part of the contact patch coincides with an end of the leading edge situated on the other side of the dividing plane entering the contact patch.

On the edges of the tread there may be circumferentially continuous grooves or even rows of blocks. In the latter instance it is sensible for the leading edges of these blocks of the edge rows to enter the contact patch according to the same rule followed by the blocks of the other rows.

For preference, the angles of the leading edges of the blocks of at least the intermediate rows are, in terms of absolute value, at most equal to 25 degrees, these angles being considered in relation to the transverse direction.

More preferably still, the mean angle of each leading edge is at least equal to 10 degrees and at most equal to 25 degrees to the transverse direction.

In an advantageous alternative form, the tread according to the invention is such that the leading edges of the blocks situated on a first side of the dividing plane have an orientation of the same sign whereas on the second side of to the dividing plane the leading edges have an orientation such that they form a V with the leading edges on the first side.

In another alternative form, the dividing plane is axially offset from the midplane of the tread so as to have at least one row more on one side than on the other side.

Advantageously, the tread according to the invention combines with any one of the above measures the presence of an odd number of rows of blocks, this number being at least equal to five.

According to another alternative form that makes it possible to increase the grip of the tread under running conditions that lead to an increase in slipperiness—notably in wet weather—it is sensible to form on at least each block of the intermediate rows a sipe of transverse overall orientation, these transverse sipes entering the contact patch in a manner offset from one another in the circumferential direction in the manner of the leading edges of the blocks.

The invention also relates to a tire provided with a tread as described hereinabove, this tire being intended to equip a drive axle of a heavy vehicle.

Other features and advantages of the invention will become apparent from the description given hereinafter with reference to the attached drawings which, by way of nonlimiting examples, show embodiments of the subject matter of the invention.

### BRIEF DESCRIPTION OF THE FIGURES

FIG. 1 is a partial view of a tread surface of a tread according to a first embodiment of the invention;

FIG. 2 is a partial view of a tread surface of a tread according to a second embodiment of the invention.

### DESCRIPTION OF SPECIFIC EMBODIMENTS

To make the figures easier to understand, the same reference symbols have been used for describing alternative forms of the invention where these reference symbols refer to elements of the same kind, whether this is structurally or functionally

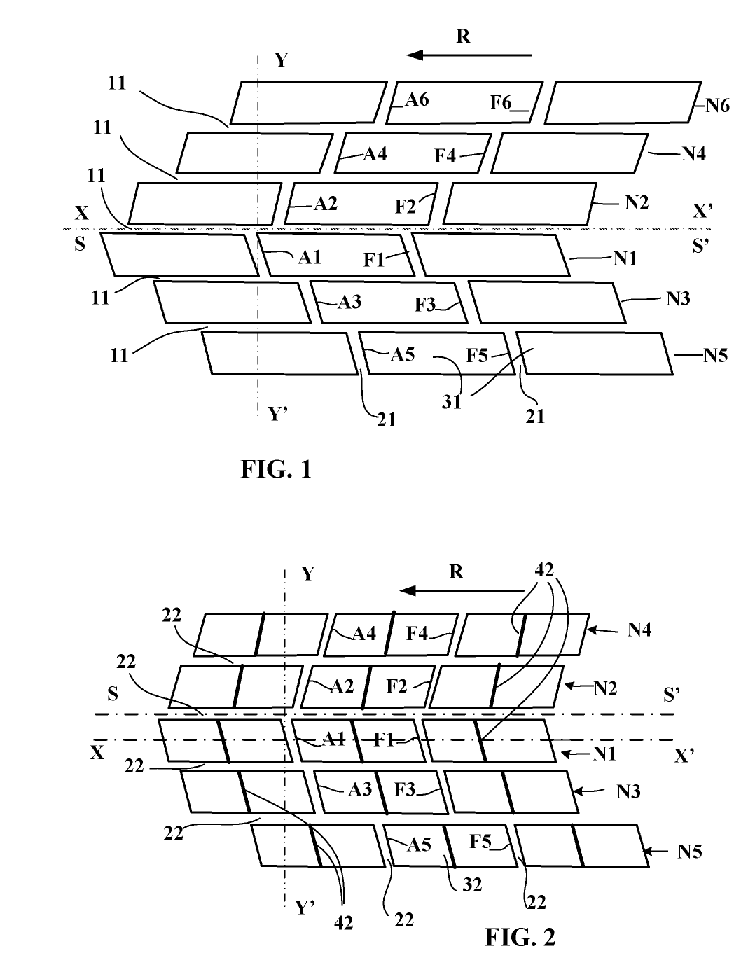

FIG. 1 shows a first alternative form of a tread according to the invention. This FIG. 1 shows a partial view of the tread surface of a tread provided with a tread pattern that has six rows of blocks delimiting five circumferential straight grooves. This tread pattern is directional which means to say it imposes a preferred direction of running in order to achieve the expected performance. This direction of running is indicated by an arrow R in this figure and may be indicated by any appropriate means on the tire provided with this tread.

This tread comprises four intermediate rows axially on either side of the shoulder or edge rows.

This tread is divided into two halves of equal width by a midplane embodied by its intersection with the plane of the figure by a straight line XX′. An axis YY′ perpendicular to the axis XX′ represents the transverse direction or even that corresponding to the axis of rotation of the tire provided with the said tread.

The tread comprises oblique grooves 21 opening into the circumferential grooves 11 to form therewith a plurality of blocks 31.

Each block 31 comprises a contact face visible in the plane of FIG. 1, this contact face being delimited, at the front, by a leading edge (denoted Ai), this edge corresponding to the first edge of the block that enters the contact patch first (the direction of rotation is indicated by an arrow R) and at the rear by a trailing edge (denoted Fi), this edge corresponding to the last edge of the block to leave the contact patch during running The index i corresponds to the row number: for example the row N1 has the index 1 and therefore the leading edges A1 and the trailing edges F1.

In this first alternative form, the tread pattern is near symmetrical, the dividing plane (identified by its line SS′) being coincident with the midplane (denoted XX′). This plane separates on its left three rows of blocks the leading edges Ai and trailing edges Fi of which make one and the same first angle with respect to the transverse direction (this direction being embodied here by the direction YY′), and on its right two rows of blocks the leading and trailing edges of which make one and the same second angle with respect to the transverse direction, this second angle being of opposite sign to the sign of the edges of the first side. Overall, the leading and trailing edges of the blocks situated on each side of the dividing plane form a kind of V pattern, this pattern pointing in the direction of running indicated by the arrow R. Near symmetrical here means that the numbers of rows situated on each side of the dividing plane are identical.

The rows of blocks are numbered using references N1 to N6 starting with the row N1 situated on one side (“first side”) with respect to the midplane and as close as possible thereto, followed by the row N2 switching to the other side (“second side”) of the midplane and returning to the first side for N3 and so on as far as N6 working progressively away from the midplane (all the even-numbered indices are therefore on the second side of the midplane with all the odd-numbered indices on the first side).

The midplane XX′ in this case corresponds to the dividing plane of this design of tread pattern whereas the dividing plane distinguishes a first side on the left of this plane on which the leading edges of all the blocks have an orientation of the same sign, and a second side to the right of this midplane XX′ in which the leading edges of all the blocks have an orientation of opposite sign to that of the first side.

The leading edges are referenced by Ai, i corresponding to the index for the row in which the block in question is to be found. The same is true of the trailing edges denoted Fi generically.

The leading edges Ai are positioned so that they enter the contact patch in a manner offset from one another and in such a way that the leading edge of a block situated on one side of the dividing plane is followed into the contact patch by a leading edge of a block situated on the other side of this plane. This alternation repeats throughout the tire that has a tread such as this.

Thus, during running, the leading edge A1 of a block from row N1 on the first side enters the contact patch followed by a leading edge A2 from a block in row N2 situated on the second side of the tread with respect to the midplane (in this example, the midplane coincides with the dividing plane). This leading edge A2 of a block from row N2 is, once it is fully in the contact patch, followed by the entry of a leading edge A3 from a block of row N3 situated on the first side of the tread with respect to the midplane, itself followed by a leading edge A4 of a block of row N4 and then by that A5 of a block from row N5 and finally that A6 from a block from row N6. After this last edge A6, the process of the leading edges Ai coming into contact is resumed with a leading edge A1 of a block from row N1 and so on.

Furthermore, the volumes of the transverse grooves delimited by the leading edges and trailing edges facing one another are such that they enter the contact patch successively and with a small offset which is particularly good for reducing running noise.

In an alternative form that has not been shown, the switch from one side to the other may occur in an irregular manner, namely from N1 to N4 then to N3 then to N6 then to N5 and then finally to N2.

In an advantageous alternative form, it is recommended that there be a small overlap between the transverse grooves considered in twos. What is meant by an overlap is that before a leading edge has fully entered the contact patch, a volume of transverse groove has partially entered the contact patch although without the leading edge delimiting this volume having itself entered the contact patch.

FIG. 2 shows a second alternative form of a tread according to the invention.

In this alternative form, a tread for a tire of a heavy vehicle comprises a directional tread pattern design, which means to say one imposing a direction of running (here indicated by an arrow R). This design is formed of four circumferential grooves 12 delimiting three intermediate rows N1, N2, N3 and two shoulder rows N4, N5. Each row comprises a plurality of grooves with oblique orientation 22 forming an angle equal in absolute terms to 15 degrees with the YY′ direction (transverse direction). These oblique grooves delimit a plurality of blocks 32 in each row.

In this second alternative form, the tread pattern design is such that the dividing plane (identified by its line SS′) is positioned in the middle of the circumferential groove separating to its left three rows of blocks of which the leading edges Ai and trailing edges Fi form one and the same first angle with respect to the transverse direction (this direction being shown here as the direction YY′) and to its right two rows of blocks of which the leading edges Ai and trailing edges Fi form one and the same second angle with respect to the transverse direction, this second angle being of opposite sign to that of the edges of the first side.

This dividing plane (identified by its line SS′) therefore divides the tread into a first side to the left of said plane, this first side comprising three rows of blocks denoted N1, N3 and N5, and a second side to the right of the dividing plane, this second side comprising two rows denoted N2, N4.

The dividing plane SS′ is offset from the midplane XX′ that divides the tread into two halves of equal widths.

The arrangement of the blocks 31 of the various rows is such that each leading edge Ai comes into contact in its entirety and successively, which means to say that two leading edges do not come completely or partially into the contact patch at the same time.

In the alternative form shown in this FIG. 2, the arrangement of the leading edges is such that as soon as one leading edge on one side of the tread has finished entering the contact patch, another leading edge on the other side of the dividing plane comes into the contact patch. Geometrically, what that means is that the end of a leading edge that is last to enter the contact patch coincides with the entry into the contact patch of a first point of a leading edge situated on the other side with respect to the dividing plane.

Furthermore, each block 31 is provided with a sipe 42, of oblique orientation, the sipes coming into contact in a way that is offset from one another in the circumferential direction just like the leading edges of the blocks.

As was mentioned with the support of FIG. 1, the volumes of oblique grooves between two blocks of each row enter the contact patch in a manner that is offset in the circumferential direction so as to further reduce the noise associated with entering and leaving the contact patch for contact with the roadway during running However, there is a slight overlap between the transverse grooves considered in pairs. This slight overlap can be quantified to at most 10% of the total area of each groove.

The invention described here by means of two exemplary embodiments is not of course restricted to these two embodiments alone and various modifications may be made thereto without thereby departing from the scope defined by the claims.

1. A tread for a tire adapted to equip a heavy vehicle, having a tread surface adapted to come into contact with a roadway and to form a contact patch, this tread comprising
a plurality of grooves of circumferential overall orientation and a plurality of grooves of oblique overall orientation intersecting the grooves of circumferential overall orientation to delimit blocks, these circumferential and transverse grooves forming a directional tread pattern, this directional tread pattern imposing a running direction on the tread,
a dividing plane separating part of the pattern to the left of the plane and part of the pattern to the right,
the circumferential grooves delimiting at least three intermediate rows formed of a plurality of blocks and two edge rows situated axially on the outside of the intermediate rows, this tread being such that each block of the rows of blocks comprises a contact face forming part of the tread surface, a front face and a rear face and two lateral faces,
the front face and the rear face intersecting the contact face along a leading edge Ai and a trailing edge Fi respectively, the leading edge of a block coming into the contact patch during running before the trailing edge of the same block when the tread is running in the running direction, wherein the directional tread pattern is designed so that the leading edges Ai of all the blocks of the rows formed of blocks are offset from one another in the circumferential direction in a suitable way that:
these leading edges successively enter the contact patch during running,
these leading edges enter the contact patch alternately on one side of the dividing plane and then on the other side of the same dividing plane in a back-and-forth arrangement.

2- (canceled)

3- The tread for a tire according to claim 1, wherein the succession whereby the leading edges Ai of all the blocks enter the contact patch is such that the end of the last leading edge forming part of the contact patch coincides with an end of the leading edge situated on the other side of the dividing plane entering the contact patch.

4- The tread according to claim 1, wherein the angles of the leading edges Ai of all the blocks are, in terms of absolute value, greater than 0 degrees and at most equal to 25 degrees to the transverse direction.

5- The tread for a tire according to claim 4, wherein each leading edge Ai of all the blocks of the intermediate rows makes a mean angle at least equal to 10 degrees and at most equal to 25 degrees to the transverse direction.

6- The tread for a tire according to claim 1, wherein the dividing plane is axially offset with respect to the equatorial plane of the tire, the leading edges of the blocks situated on a first side of the dividing plane having an orientation of the same sign whereas on the second side the leading edges have an orientation such that they form a V with the edges on the first side, so as to have at least one more row on one side than on the other side.

7- The tread for a tire according to claim 1, wherein the tread comprises an odd number of rows of blocks, this number being at least equal to five.

8- The tread for a tire according to claim 7, wherein each block is provided with at least one sipe of transverse overall orientation, these transverse sipes entering the contact patch in a manner offset from one another in the circumferential direction in the manner of the leading edges of the blocks.

9- A tire comprising a tread according to claim 1, wherein there is an overlap in the contact patch between the transverse grooves considered in twos, this overlap representing at most 10% of the surface area of these grooves.

10- The tire according to claim 9, this tire being adapted to equip a drive axle of a heavy vehicle.
